(19) United States
(12) Patent Application Publication
(10) Pub. No.: US 2009/0267469 A1
(43) Pub. Date: Oct. 29, 2009

(54) Outdoor furniture

(75) Inventor: Gaelle STUIT, Voeuil Et Giget (FR)

Correspondence Address: Perman & Green, LLP, 99 Hawley Lane, Stratford, CT, 06614, US

(73) Assignee: ETS A. DESCHAMPS ET FILS, La Couronne (FR)

(21) Appl. No.: 12/425,169

(22) Filed: Apr. 16, 2009

(30) Foreign Application Priority Data
Apr. 17, 2008 (FR) 08 52605

(51) Int. Cl. A47B 87/00; A47B 97/00; G06Q 30/00

(52) U.S. Cl. 312/271; 312/349; 705/14.4

(57) ABSTRACT

An outdoor furniture includes a main body with at least one compartment and one door to close the compartment. The main body has at least one transverse recess intended to hold an organ for moving the furniture. The recesses have longitudinal parallel and/or perpendicular axes to allow the outdoor furniture to be handled from at least one side of the main body or from at least two contiguous sides of the main body. The main body can be in one block made of molded plastic material.

### CROSS-REFERENCE TO RELATED APPLICATIONS

This application claims priority from French Application No. 0852605, filed on 17 Apr. 2008, the disclosure of which is incorporated herein by reference in its entirety.

### BACKGROUND

1. Field

The disclosed embodiments concern outdoor furniture to hold personal effects and/or motorized or non-motorized vehicles. More specifically, it concerns an outdoor locker facility, particularly at the beach.

2. Brief Description of Related Developments

Such locker facilities are known and used in enclosed places, such as train stations, airports, or even outside, for example at the beach, to hold personnel effects safely temporarily.

These locker facilities generally include a plurality of lockers, each designed to hold one or more objects to be protected, and each equipped with a locked door and an individualized locking mechanism to lock said door.

After the user pays a fee, he receives a key or code allowing him to unlock said door and access the contents of the locker in which he has deposited his personal effects, so he can recover them.

However, these locker facilities are generally stationary and very hard to move.

It is known how to place each of these lockers on a base such as a plank to make them easy to move. But this diminishes the aesthetic look of such a unit.

Moreover, the deterioration of these planks over time due to repeated exposure to bad weather weakens their general structure. Then, it is possible for them to start rocking, which can eventually prove dangerous to users.

These lockers are also complicated, since they are composed of a group of separate pieces put together. The assembly time for these lockers can consequently be relatively long and require qualified operators.

Such lockers also have a large number of interstices that provide many potential paths for particles of sand and/or dust to get inside the lockers, when they are used at the beach.

Consequently, maintaining and cleaning these lockers can involve drudgery.

What is more, if personnel effects are deposited in these beach lockers for a prolonged period of time, it is possible to see the presence of particles of sand in or on the effects, which can potentially affect their proper operation if they are electronic devices.

There is therefore a pressing need for a locker that can easily be moved from one geographic area to another and is tight enough to prevent a large number of particles of sand from getting into the lockers.

### SUMMARY

The objective of the disclosed embodiments are therefore to propose outdoor furniture, such as a compartment to deposit personal effects and/or motorized or non-motorized vehicles, that has a simple design, is simple to operate and can easily be moved using a forklift.

Another objective is outdoor furniture for depositing personal effects and/or motorized or non-motorized vehicles, all in one block, thus giving it mechanical properties superior to the outside furniture in the state of the art obtained by assembling a plurality of initially separate pieces.

Another objective of the disclosed embodiments is outdoor furniture for depositing personal effects and/or motorized or non-motorized vehicles, offering users multiple services, such as displaying information and/or advertising messages, temporary storage of an urban wheelchair and exchanging it for a chair made to move on sandy soil, a stroller, storing a buoyant vehicle or an inflatable raft.

For this purpose, the disclosed embodiments concern outdoor furniture that has a main body with at least one compartment and a door to close the compartment.

According to the disclosed embodiments, the main body has at least one transverse recess designed to hold an organ for moving the furniture, and the recesses have parallel and/or perpendicular longitudinal axes to permit handing this outdoor furniture on at least one side of the main body or at least two contiguous sides of the main body, respectively, the bottom part of the main body has a supporting surface whose dimensions ensure that the outdoor furniture does not sink into unstable soil.

A “transverse recess” is understood as a recess with a longitudinal axis perpendicular or almost perpendicular to the main axis of the main body of the outdoor furniture. The transport organ is therefore placed in such a way as to support this main body when the outdoor furniture is being moved.

These moving organs can be the forks of a forklift or pallet truck. The main body then includes at least two transverse recesses whose longitudinal axes are coplanar and parallel to each other to within manufacturing errors.

Of course, each of these transverse recesses is designed to take one of these forks, and the distance separating these at least two recesses approximately corresponds to the difference between the forks of the forklift or pallet truck.

Alternately, this main body may include only one recess that opens out to hold a bar, each end of which is connected to a pair of low-pressure wheels, which makes it possible to move the outdoor furniture from one geographic area to another.

Preferably, these recesses, whether or not they open out, are placed on the bottom part of the main body to make it easier to handle the outdoor furniture.

“Unstable soil” is understood to mean soil like sandy, snowy or muddy soil.

In different special embodiments of this outdoor furniture, each having its special advantages and capable of many potential technical combinations:

The main body is a main body all in one block made of molded plastic.

Advantageously, this main body may be transparent, so that it will be possible to see the contents from the outside. The outdoor furniture will then be made of polycarbonate or acrylonitrile butadiene styrene (ABS).

Preferably, this furniture may also include at least one display screen to display information or advertising messages, which will be located inside the main body of the furniture to protect it from external attack.

Alternately, this main body could also be made of a biodegradable material, since the outdoor furniture is temporary.

The recesses open out to allow the outdoor furniture to be handled by two opposite sides of this main body or by the four sides of the main body.

The furniture includes, for at least some of said compartments, an individualized locking organ that makes it possible to lock the doors of these compartments.

The furniture includes at least one removable or non-removable projecting element placed on the main body so that its top surface forms a bench or seat.

This projecting element also forms a male anchoring organ or a female receptacle, designed to cooperate with a female receptacle or respectively a male anchoring organ of other outdoor furniture so they can be assembled.

The furniture has at least one joining piece, and the main body of this furniture has at least one hollow place designed to cooperate with part of this joining piece to allow this furniture to be assembled with this piece; this joining piece is designed to allow said outdoor furniture to be assembled with other outdoor furniture.

The main body is flared from top to bottom.

Purely as an illustration, this flared part can be shaped like a cone, a truncated cone, a pyramid or the trunk of a pyramid.

This flared shape is an advantage in that it makes it possible to keep the doors closed when they are not locked, so they do not flap in the wind.

The furniture includes auto wrapping that can be combined with advertising messages broadcast on at least one display screen.

The furniture includes at least one display screen to display information or advertising messages.

When the furniture is a consignment device, it may advantageously have, instead of this display screen, or in addition to it, an electronic tide clock for consignment devices at the beach. This tide clock indicates the time remaining before the next high or low tide and the time for a specific place. The electronic tide clock sold by the Mamias Company in Rochefort, France is particularly well suited for this.

The furniture includes a data storage unit containing information and/or advertising messages, a display unit to extract the data from the storage unit and generate signals for displaying this information and/or advertising messages toward said at least one display screen.

The disclosed embodiments also concern a set of outdoor furniture that includes at least two pieces of outdoor furniture, as described previously, assembled or not.

When this furniture is not assembled, it can be placed side by side to offer a greater volume of storage.

This set can also consist of a network of furniture placed in different geographic positions to form a grid, for example on a beach or in an urban space.

Advantageously, each piece of furniture in this set includes at least one display screen; this set includes a central processing unit with a central storage unit to store information and/or advertising messages intended to be displayed by the display screens of the outdoor furniture. This central processing unit includes a transmitter to transmit signals to display this information and/or advertising messages to each piece of outside furniture, which includes means of receiving the signals.

The disclosed embodiments also concern a consignment device to deposit and recover an object. According to the disclosed embodiments, this consignment device includes at least one piece of outdoor furniture, as previously described.

Such a consignment device has the advantage that it can be positioned near an activity/attraction of an amusement park, since such parks are large, and the state-of-the-art locker systems are generally found solely at their entrances.

Preferably, the main body has a recess with a vertical axis opening onto the bottom and/or top part of said main body to form an air duct for the different compartments, with the compartments forming lockers.

Moreover, at least some of these compartments can include an element chosen from the group including a light source to illuminate said compartment, an electric plug to power electric or electronic devices, a flexible container designed to be mounted inside said door to hold small-size objects, a wheelchair equipped with at least one low-pressure wheel, an electric power source to power said consignment device and a combination of these elements.

The disclosed embodiments will be described in greater detail with reference to the attached drawings:

### BRIEF DESCRIPTION OF THE DRAWINGS

FIG. 1 is a perspective view of a piece of outdoor furniture designed to hold personnel effects on consignment according to an initial embodiment of the disclosed embodiments;

FIG. 2 is a perspective view of a set of two pieces of outdoor furniture designed to hold personnel effects on consignment according to a second embodiment of the disclosed embodiments;

FIG. 3 is a perspective view of a set of two pieces of outdoor furniture designed to hold personal effects and/or a motorized or non-motorized vehicle according to a third embodiment of the disclosed embodiments;

FIG. 4 shows an enlarged view of the element forming the projection of the main body of a first consignment device in FIG. 3;

FIG. 5 shows an enlarged view of the element designed to form a projection of the main body of a piece of outdoor furniture according to another embodiment.

FIG. 6 is a perspective view of one piece of the outdoor furniture in FIG. 3 without its roof; this piece of furniture has a single compartment designed to hold a wheelchair in the folded position;

FIG. 7 is a view from below of a set of three pieces of outdoor furniture showing the recesses designed to hold the organs for moving each piece of furniture; FIG. 7a shows these pieces separated from one another with their joining piece; and FIG. 7b) shows these pieces after assembly.

### DETAILED DESCRIPTION OF THE DISCLOSED EMBODIMENTS

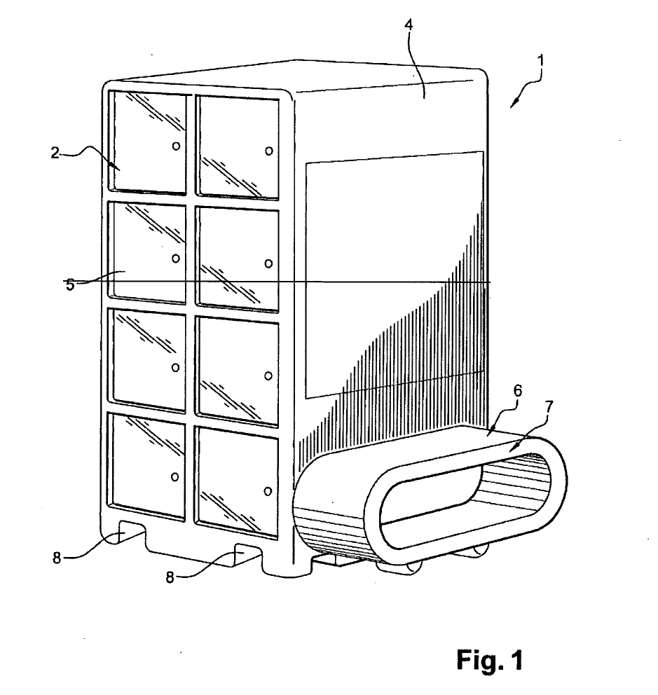

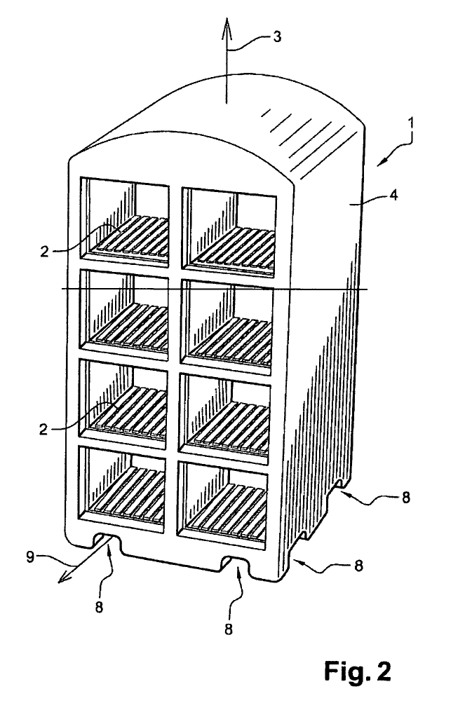

FIG. 1 shows a perspective view of a piece of outdoor furniture designed to hold consigned personnel effects, according to a first embodiment of the disclosed embodiments. This outdoor furniture includes a main body 1 having a plurality of lockers 2 placed on both opposite sides of the main body 1. This main body 1 has a main axis 3 that is vertical.

This main body 1 is made of a molded plastic material. Preferably, it is obtained by rotational molding. The plastic material may be chosen from the group that includes polyethylene, particularly HDPE; polyamide, particularly PA 6.6; polypropylene; acrylonitrile butadiene styrene (ABS); polyester and even rigid PVC.

Since the main body 1 is in one piece and is consequently not a result of assembling a plurality of initially separate pieces, this will limit the potential penetration of sand or dust inside the furniture. Moreover, since the lockers are located on two opposite sides, it will be possible and an advantage to have one side 4 without lockers face the wind.

These lockers have the advantage of a parallelepiped shape and at least some of them have the same height h and the same depth p.

Each locker 2 includes a door 5 that closes mounted on the main body and an individualized locking organ (not shown) in the closed position on said door 5. This individualized organ includes a locking mechanism and an unlocking organ for this locking mechanism to allow the corresponding door to be opened.

This unlocking organ and the locking mechanism are controlled by a locker control system placed in a locker 2 of this furniture and made accessible solely to an operator of this outdoor furniture.

A ticket is issued on condition of payment of an amount that can be paid either in cash or by bank payment, with the centralized system including a payment terminal that accepts bank cards. Of course, the outdoor furniture has an aerial for transmission/reception (not shown) that makes it possible to send the data read to bank servers.

Preferably, each locker 2 is equipped with a jack that makes it possible to recharge a cell phone or a laptop computer. Each locker 2 can also have a light source for night-time use, for example, and a flexible container such as a bag mounted inside on the locker door to hold small-size objects such as rings, watches, etc.

To make sure the outdoor furniture has a power supply for the electric and/or electronic equipment, it can be equipped with a battery with a long life that can be rechargeable. In that case, it will have a solar or similar panel to power the rechargeable battery on the top of the main body. The battery can be in a locker 2 located, for example, on top of the main body 1, access to which will have been forbidden to users of this outside furniture.

The bare surfaces 4 of the main body can serve as a support to display communications. Preferably, at least one of these surfaces 4 can hold an LCD-type display screen protected from bad weather and abrasion, which is linked to the destination of the outdoor furniture by a transparent protective surface, such as a plate made of plastic material or abrasion-proof safety glass.

This display screen can then be connected to a reader placed in a locked locker with an external hard drive on which will have already been recorded informational messages (time of low and high tides, meteorological data . . . ) and/or advertising messages intended to be displayed in a loop on the display screen.

The lockers 2 are voluntarily located on two opposite sides of the main body 1, so that they are placed back to back forming a space between them. This makes an opening between the bases of the lockers for venting and/or mounting an electrical support in the base of the locker.

This opening also makes it possible to distribute the connections (electric cables, data transmission cables, . . . ) between each locker and the external or internal equipment and/or the power source for the outside furniture.

The main body 1 also has a projecting element 6 placed on the main body so that its top surface 7 forms a bench. This projecting element 6 has recesses in it and consequently forms a female receptacle which is designed to cooperate with a male anchoring organ of another piece of outdoor furniture for assembling these devices. When the furniture is thus assembled, these male and female receptacles then form a seat.

This modularity makes it possible to adapt the number of lockers 2 necessary to the leisure site.

The main body 1 can be decorated with a sign, a 3D sign structure or auto wrapping that can be associated with advertising messages broadcast on the LCD-type display screen.

The main body 1 also has two vented recesses 8 on each side of it to allow the outdoor furniture to be handled on three sides of this main body 1, with the fourth holding said projecting element.

For each side, these two vented recesses 8 are coplanar, having their respective longitudinal axes 9 parallel. These recesses 8 here form transverse grooves in the lower part of the main body 1.

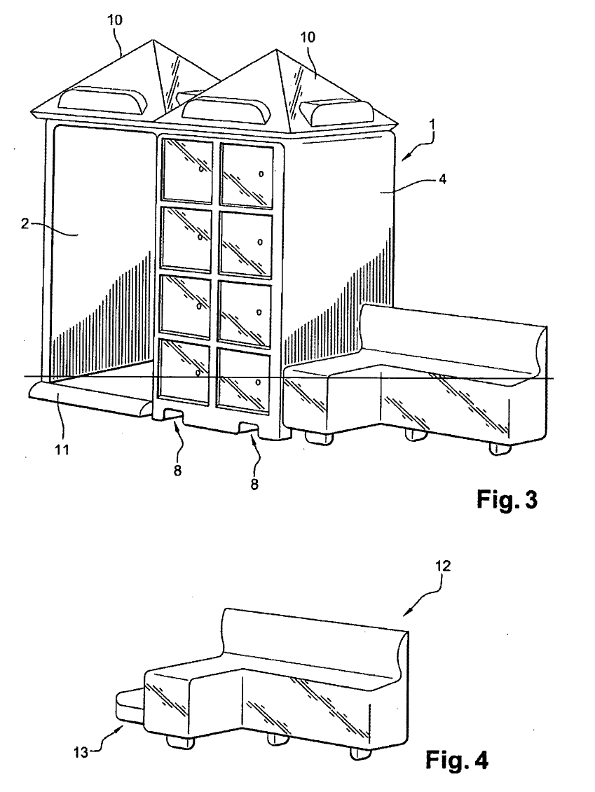

FIG. 3 shows a set of outdoor furniture. The elements in FIG. 3 have the same reference numbers as the elements in FIG. 1 representing the same objects.

This outdoor furniture is distinguished from that in FIG. 1 by the fact that it is joined by one side 4 which is bare and by the fact that each one has a roof 10.

One piece of this furniture has only one locker 2 or compartment comprising approximately the whole height of the main body 1. It also has an access ramp 11 to this locker 2, which makes it possible to put in it a wheeled vehicle such as a wheelchair, a stroller, . . . in the folded position or a buoyant vehicle, such as an inflatable lifeboat or motorized nautical vehicle, such as a jet ski. Potentially, the inflatable boat can also be on its trailer.

It is thus possible to provide for a wheelchair made to move on unstable soil, such as sand, or an amphibious wheelchair, which a person with limited mobility can exchange for his city chair so as to get around on unstable soil and/or a beach or pool.

Of course, the recess or recesses 8 designed to hold the organ or organs of movement for the outdoor furniture can be placed in the intermediate and/or top part of the main body 1 and not necessarily in just the bottom part serving as the base.

A piece of outdoor furniture designed to take a wheelchair can advantageously have at least one transverse recess placed on the main body 1 out of this lower part so that the end of the bottom part and hence the area of access to the single locker 2 designed to contain the wheelchair is placed on ground level. Then, it is no longer necessary to have an access ramp 11 to the locker 2, which is not elevated in relation to the ground.

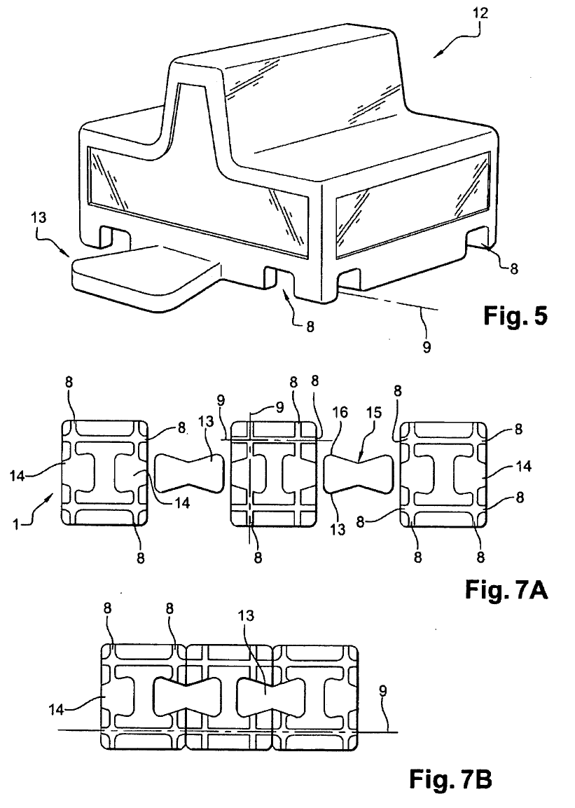

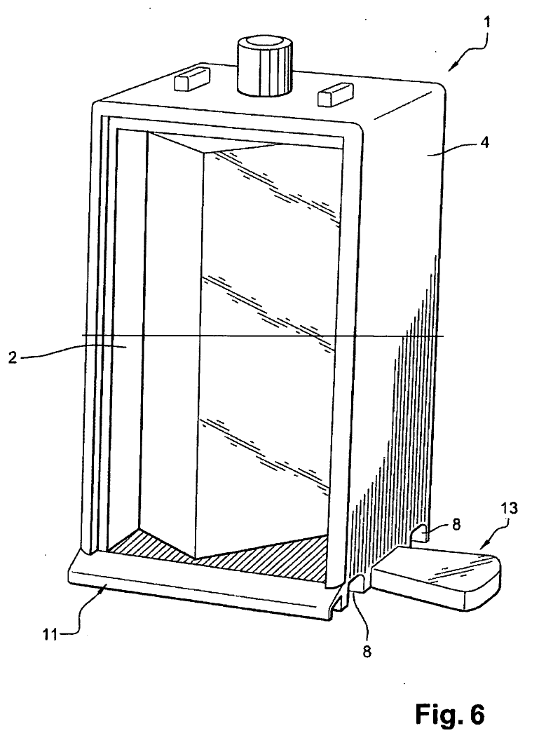

FIGS. 3 and 4 also show a projecting element removable from the main body 1 in the form of a bench 12. FIG. 5 shows such a bench 12 in another embodiment. The latter, which allows a two-sided seat also has transverse recesses 8 designed for an organ for moving said projecting element. On the edge of this bench, there is a joining piece 13, which may or may not be integral with the bench and allows the bench to be assembled with the main body 1 of a piece of outdoor furniture.

FIG. 7 shows a view from below of a set of three pieces of outdoor furniture and the joining pieces 13 that allow them to be assembled to form a set. The bottom part of the main body 1 of this outdoor furniture has not only transverse recesses 8 that allow one or more organs for moving this furniture from one or more sides of this main body 1, but also has one or more recesses 14, each designed to cooperate with a part of a joining piece 13.

This joining piece 13 is designed to be placed on top between two pieces of outdoor furniture placed side by side so as to connect this furniture and make sure it is solid.

Purely for the sake of illustration, this joining piece 13 has a section that increases from the center 15 toward the ends 16, and this section is designed to fit into a hollow section 14 that works with this section to connect the joining piece 13 and the outdoor furniture.

This joining piece 13 can be made of plastic.

Of course, when the soil intended for the outdoor furniture is hard, such as paved ground, these joining pieces 13 are optional. One need only place the outdoor furniture side by side to form a set.

What is claimed is:

1. Outdoor furniture that includes a main body with at least one compartment, and one door to close said compartment,
wherein said main body has at least one transverse recess configured to hold an organ for moving said furniture; said recesses have longitudinal parallel and/or perpendicular axes to allow said outdoor furniture to be handled from at least one side of said main body or from at least two contiguous sides of said main body (1), and
said main body is a main body in one block made of molded plastic material.

2. The furniture according to claim 1, wherein said main body is made of polycarbonate or acrylonitrile butadiene styrene (ABS) so as to be transparent.

3. The furniture according to claim 1, wherein said recesses open out so that said outdoor furniture can be handled by two opposite sides of said main body or by the four sides of said main body.

4. The furniture according to claim 1, further comprising at least one projecting element, removable or not, and said projecting element is placed on said main body so that the top of it forms a bench.

5. The furniture according to claim 4, wherein said projecting element also forms a male anchoring organ or a female receptacle, designed to cooperate with a female receptacle, or respectively a male anchoring organ, of another piece of outdoor furniture so that they can be put together.

6. The furniture according to claim 1, wherein said furniture has at least one joining piece and said main body has at least one hollow space designed to cooperate with part of said joining piece to allow said furniture to be assembled with said joining piece, and said joining piece is designed to allow said outdoor furniture to be put together with another piece of outdoor furniture.

7. The furniture according to claim 1, further comprising auto wrapping that can be connected with advertising messages broadcast on at least one display screen.

8. The furniture according to claim 1, further comprising at least one display screen to display information or advertising messages.

9. A set of outdoor furniture including at least two pieces of outdoor furniture according to claim 1, with said outdoor furniture being assembled or not.

10. The set according to claim 9, wherein each piece of said furniture has at least one display screen, and the set includes a central processing unit with a central storage unit to store information and/or advertising messages intended to be displayed by said display screens of said outdoor furniture, and said central processing unit has a transmitter to transmit display signals of said information and/or said advertising messages to each piece of said outdoor furniture, which has means of receiving said signals.

11. A consignment device to deposit and recover an object, characterized by the fact that it includes at least one piece of outdoor furniture according to claim 1.

12. The device according to claim 11, wherein at least some of said compartments include an element chosen from the group including a light source to illuminate said compartment, a power outlet to power electric or electronic devices, a flexible container designed to be mounted on the inside of said door to hold small-size objects, a wheelchair equipped with at least one low-pressure wheel, an electric power source to power said consignment device and a combination of these elements.
